(19) United States
(12) Patent Application Publication
(10) Pub. No.: US 2006/0037851 A1
(43) Pub. Date: Feb. 23, 2006

(54) SIDE PUSH SWITCH

(76) Inventors: Yong Hui Hu, Tu-Chen (TW); Yusho Nakase, Fu Jin (JP)

Correspondence Address: WEI TE CHUNG;FOXCONN INTERNATIONAL, INC., 1650 MEMOREX DRIVE, SANTA CLARA, CA, 95050, US

(21) Appl. No.: 11/126,020

(22) Filed: May 9, 2005

(30) Foreign Application Priority Data
Aug. 17, 2004 (CN) 200420078890X

(51) Int. Cl. H01H 5/18

(52) U.S. Cl. 200/406

(57) ABSTRACT

A side push switch includes an insulative housing (1), a periphery contact (22), a central contact (25), a dome (3), a lever (5) and an actuator (5) mounted on the lever. The dome is disposed over the central contact and electrically connects with the periphery contact. The lever is formed with a transversal branch (51) and a longitudinal branch (52) extending from the transversal branch. A pair of trunnions (510) are respectively formed at opposite ends of the transversal branch. A depressing portion (520) is formed on the longitudinal branch. An actuating follower (521) is formed at a free end of the longitudinal branch. The actuator has a ramp (45) engaging with the actuating follower of the lever thereby causing the lever depressing the dome to connect the periphery contact and the central contact.

### BACKGROUND OF THE INVENTION

1. Field of the Invention

The present invention relates to a miniature side push switch (e.g. 1-3 mm high side push switch), and particularly to a miniature switch used in consumer electronic applications.

2. Description of the Prior Art

The personal electronic consumer productions such as cell phones are designed to comply with a miniature trend as the customers require. Correspondingly, electronic elements such as switches employed in those productions are required to be miniature.

A conventional switch is disclosed in U.S. patent application publication number 2004/0238341. The switch comprises a housing, a plurality of electrical contacts mounted in the housing, a contact plate mounted on the housing for establishing electrical connections between the electrical contacts, a dome disposing on the contact plate for pushing the contact plate against the electrical contacts, a rigid lever positioning on the dome for snap down the dome to actuate the contact blade, and an actuator for driving the rigid lever actuate the dome. The rigid lever has a T-shaped configuration and is formed with a laterally extended rear branch. A central branch rearwardly extends from the rear branch and forms a cam follower upper surface at an upper surface of a free end thereof. A pair of trunnions is respectively formed at opposite ends of the rear branch. The trunnions engage with the housing, so that the rigid is pivotal on an axis of the rear branch. The actuator comprises a rear actuating face at rear end and a ramp at front end. The ramp of the actuator engages with cam follower upper surface. When an external force exerts on the actuator, the actuator is pushed forwardly, the ramp abuts against the cam follower upper surface, and thus the ramp transfers the force downwardly thereby depressing the cam follower downwardly. The rigid lever is pressed to pivot and depress the dome that causes the contact plate contacting the electrical contacts in turn.

Though the conventional switch works well, there's some problem it can not solve. To ensure reliable connections, the force transfer member such as the actuator, the lever and the dome are regarded as essentials of the switch. The rigid lever is molded of plastic material, which can avoid deflection and ensure well performance when it depresses the dome. However, as the switch is so mini in size, every part in the switch is very small, a rigid lever made of plastic may easily be scratched, which effects the lifetime of the switch.

Hence, an improved switch is required to overcome the disadvantages of the prior art.

### BRIEF SUMMARY OF THE INVENTION

An object of the present invention is to provide a side push switch with an improved resilient lever.

A side push switch in according with the present invention comprises an insulative housing, a periphery contact and a central contact, a dome, a lever and an actuator mounted on the lever. The contacts are received in the housing by insert molding and respectively form with a first terminal and a second terminal extending out the housing, of which the central contact keeps electrically isolated from the periphery contact in normal status. The dome is disposed over the central contact and electrically connects with the periphery contact. The lever is made of metal material and is formed with a transversal branch and a longitudinal branch laterally extending from the transversal branch. A pair of trunnions are respectively formed at opposite ends of the transversal branch. A depressing portion is formed on the longitudinal branch. An actuating follower is formed at a free end of the longitudinal branch. The actuator has a ramp engaging with the actuating follower of the lever thereby causing the lever depressing the dome to connect the periphery contact and the central contact.

The lever of the switch is made of metal material, and it's endurable avoiding the lever being scratched.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a switch according to the present invention;

FIG. 2 is an exploded view of the switch in FIG. 1;

FIG. 3 is another exploded view of the switch in FIG. 1;

FIG. 4 is a sectional view taken on line 4-4 of FIG. 1 showing the switch in normal status; and

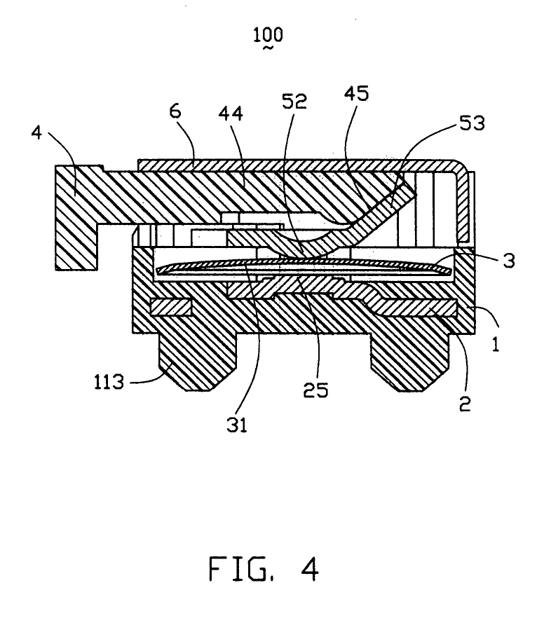

FIG. 5 is a sectional view similar to FIG. 4 while showing the switch being triggered.

### DETAILED DESCRIPTION OF THE PREFERRED EMBODIMENTS

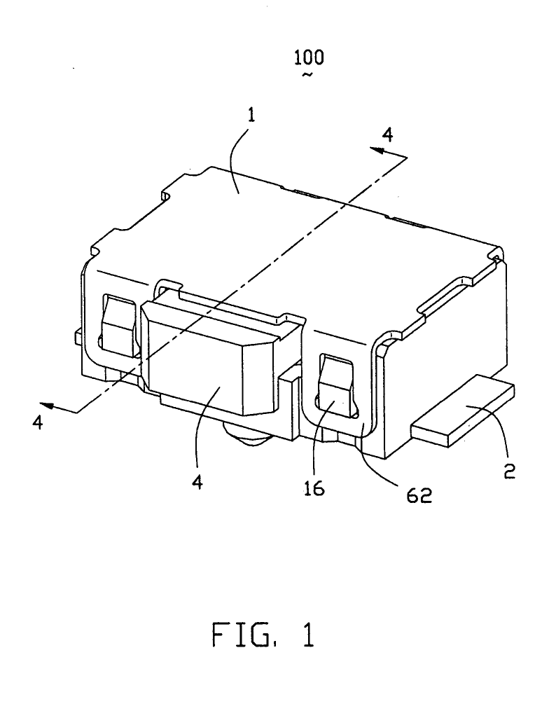

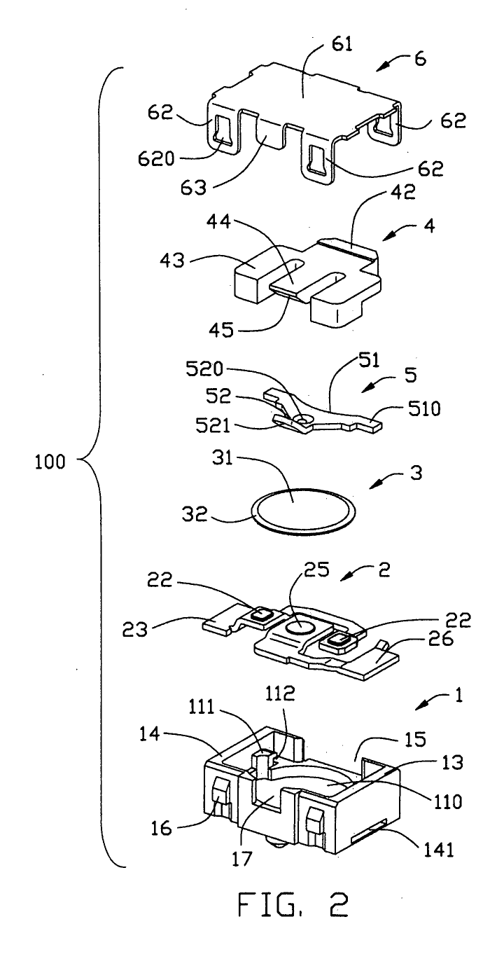

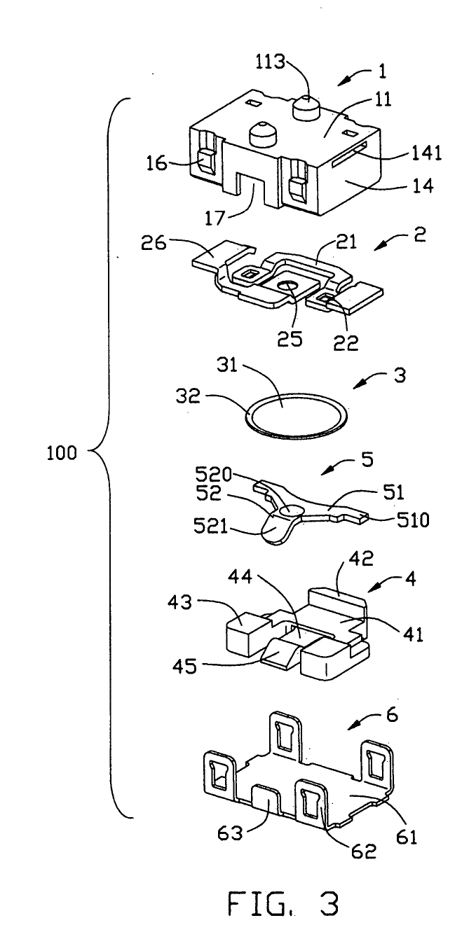

Referring to FIGS. 1, 2 and 3, a side push switch in accordance with the present invention comprises an insulative housing 1, a plurality of contacts 2, a metal dome 3, an actuator 4, a lever 5 and a cover 6.

The insulative housing 1 is substantially a rectangular case and is formed with a base 11. A pair of U-shaped side walls 13 and 14 upwardly raise from opposite longitudinal side ends of the base 11 and forms an operating cutout 15 and a rear cutout 17. A pair of slits 141 are respectively defined at the longitudinal ends near the bottom surface of the base 11. A cavity 110 is defined on an upper surface of the base 11. A pair of raised stages 111 are formed at the side of the cavity 110 and respectively adjacent to the corresponding U-shaped side walls 13 and 14, which also adjacent to the operating cutout 15. Each stage 111 forms a recess 112 at a bottom portion thereof. A plurality of projections 16 are formed on outer surfaces of the U-shaped side walls 13, 14. A pair of posts 113 project downwardly from a lower surface of the base 11.

The contacts 2 are mounted in the housing 1 by insert molding and include a periphery contact 22 and a central contact 25. The central contact 25 is mounted at the central of the base 11. The periphery contact 22 includes a pair of contacting portion (not labeled) arranged at sides of the central contact 25. A pair of first and second terminals 23 and 26 are respectively and laterally extended from the periphery contact 22 and the central contact 26.

The dome 3 is a dome-liked resilient metal plate. The dome 3 comprises an apex 31 and a contacting blade 32. When an external force exerts on the apex 31, the dome 3 is capable of converting to be reversed.

The lever 5 is made of metal material and is formed with a transverse branch 51. A pair of trunnions 510 are respectively formed at opposite ends of the transverse branch 51. A longitudinal branch 52 extends perpendicularly from a middle portion of the transverse branch 51. The longitudinal branch 52 includes a semi-spheral shaped depressing portion 520 formed at a central portion thereof and an actuating follower 521 formed by bending up a free end thereof.

As a matter of fact, the lever 5 can also be made of other resilient material. The trunnions 510 can be instead by other structures such as clasps and so on, of which the clasps fixed with the housing 1, and the lever 5 can be pressed down for its resilience.

The actuator 4 has an operating branch 42, a pair of mounting branches 43 forwardly and laterally extending from the operating branch 42 and a central branch 44 forwardly extending from the operating branch 42 between the mounting branches 43. A ramp 45 is formed at a free end of the central branch 44, which has a same gradient corresponding to the actuating follower 521.

The cover 6 has a plan plate 61 and a plurality of tabs 62 and 63 downwardly extending from the plan plate 61. A plurality of engaging holes 620 is defined at the tabs 62 for engaging with the projections 16. The tab 63 are used for engaging with the rear cutout 17 opposite to the operating cutout 15 which are both defined by the U-shaped side walls 13 and 14.

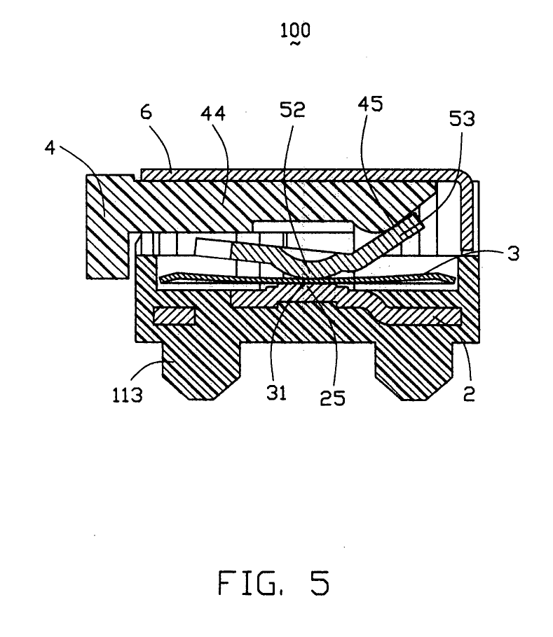

Referring to FIG. 5, in assembly, the contacts 2 are received in the housing 1 by insert molding, and the terminals 23, 26 are extended out of the housing 1 from the slits 141. The dome 3 is received in the cavity 110, of which the contacting blade 32 contacts with the periphery contact and the apex 31 is disposed over the central contact 25. The lever 5 mounts on the dome 3. The depressing portion 520 mounts on the apex 31 of the dome 3. The trunnions 510 of the lever 5 are received in the recesses 112 of the stages 111, and the lever 5 is pivotal around the trunnions 510. The actuator 4 disposes on the lever 5 and the mounting branches 43 mount on the base 11. The ramp 45 abuts against the actuating follower 521. The operating branch 42 projects beyond the operating cutout 15. The actuator 4 is slidable on the base 11. The cover 6 engages with the housing 1. The engaging holes 620 of the tabs 62 engage with the projections 16, and the tab 63 covers the rear cutout 17 that is opposite to the operating cutout 15.

In operation, an external force is exerted on the operating branch 42. The actuator 4 is pressed forward and the ramp 45 engages with the actuating follower 521 of the lever 5 thereby transferring the force from a forward direction to downward direction. Thus, the lever 5 presses the dome 3 and causes the apex 31 of dome 3 deflected to contact with the uncommon contact 25. So, an electrical connection between the periphery contact 22 and the central contact 25 is established. When the external force is removed, the dome 3 restores itself to a normal status and the connection between the dome 3 and the central contact 25 is broken. The lever 5 is upwardly pushed by the dome 3. The lever 5 pivots around the trunnions 510 thereby the actuating follower 521 pressing the ramp 45 of the actuator 4 and the switch restore itself to the normal status.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

We claim:

1. A side push switch comprising:
an insulative housing;
a periphery contact received in the housing and formed with a first terminal extending out of the housing;
a central contact received in the housing and having a second terminal extending out of the housing, the central contact electrically isolated from the periphery contact;
a dome electrically contactable with the central contact and the periphery contact;
a lever formed with a transversal branch and a longitudinal branch extending from the transversal branch, a depressing portion formed with the longitudinal branch, and a resilient actuating follower formed at a free end of the longitudinal branch; and
an actuator mounted on the lever having a ramp engaging with the actuating follower of the lever thereby causing the lever depressing the dome to connect the periphery contact and the central contact.

2. The side push switch as claimed in claim 1, wherein the lever is made of metal material.

3. The side push switch as claimed in claim 1, wherein a pair of trunnions respectively formed at opposite ends of the transversal branch,

4. The side push switch as claimed in claim 3, wherein the trunnions of the lever engages with the housing and the lever is pivotal around trunnions.

5. The side push switch as claimed in claim 1, wherein a pair of raised stages are formed in the housing, and each raised stage defines a recess at the bottom portion thereof.

6. The side push switch as claimed in claim 5, wherein the trunnions of the switch engage with the recesses of the raised stages.

7. The side push switch as claimed in claim 1, wherein the actuating follower is formed by bending up the free end of the longitudinal branch.

8. The side push switch as claimed in claim 1, wherein the actuator has an operating branch, a pair of mounting branches forwardly and laterally extending from the operating branch and a central branch forwardly extending from the operating branch between the mounting branches.

9. The side push switch as claimed in claim 8, wherein the ramp is formed at a free end of the central branch.

10. A push switch comprising:
an insulative housing;
a periphery contact received in the housing;
a central contact received in the housing and electrically isolated from the periphery contact;
a lever including a longitudinal branch pivotally moveable about a pivot axis extending in a transverse direction essentially perpendicular to said longitudinal branch; and
an actuator located above said lever and linearly reciprocated in a lengthwise direction essentially perpendicular to said transverse direction thereby causing the lever to pivotally move and actuate the central contact and the periphery contact to be electrically engaged with each other; wherein
the pivot axis is essentially located around a front face of the housing where an operation knob of the actuator is located for manually pushing by a user from an exterior.

11. The push switch as claimed in claim 10, wherein said actuator includes a first engagement section far away from the operation knob, and said lever includes a second engagement section far away from the pivot axis, said engagement section and said second engagement section engaged with each other to actuate said lever.

12. The push switch as claimed in claim 10, wherein said actuator is spaced, in a vertical direction perpendicular to both said lengthwise direction and said transverse direction, from an end portion of the lever where the pivot axis is located.

13. The push switch as claimed in claim 10, wherein a deflectable dome is actuated by the actuated lever to result in electrical connection between the central contact and the periphery contact.

14. A push switch comprising:
an insulative housing;
a first contact received in the housing;
a second contact received in the housing and electrically isolated from the first contact;
a lever including a longitudinal branch pivotally moveable about a pivot axis extending in a transverse direction essentially perpendicular to said longitudinal branch; and
an actuator located above said lever and linearly reciprocated in a lengthwise direction essentially perpendicular to said transverse direction thereby causing the lever to pivotally move and actuate the first contact and the second contact to be electrically engaged with each other; wherein
the actuator includes a first engagement section, the lever includes a second engagement section engaged with each other in a vertical direction when the actuator is moved to an inner actuation position, under a condition that both said actuator and said lever are essentially located on a same side of said interengaged first and second engagement sections with regard to a transverse axis passing said interengaged first and second engagement sections.

15. The push switch as claimed in claim 14, wherein said actuator is spaced, in a vertical direction perpendicular to said lengthwise direction and said transverse direction, from an end portion of the lever where the pivot axis is located.

16. The push switch as claimed in claim 14, wherein a deflectable dome is actuated by the actuated lever to result in electrical connection between the first contact and the second contact.
